(19) United States
(12) Patent Application Publication
(10) Pub. No.: US 2024/0054396 A1
(43) Pub. Date: Feb. 15, 2024

(54) MACHINE LEARNING (ML)-BASED SYSTEMS AND METHODS FOR AUTOMATED MATCHING ELECTRICIANS TO JOBS

(71) Applicant: Vehya LLC, Detroit, MI (US)

(72) Inventors: William Henry MCCOY, II, Detroit, MI (US); Sergey SUKHANOV, Seeheim-Jugenheim (DE)

(21) Appl. No.: 18/234,297

(22) Filed: Aug. 15, 2023

Related U.S. Application Data
(60) Provisional application No. 63/398,158, filed on Aug. 15, 2022.

(51) Int. Cl. G06N 20/00

(52) U.S. Cl. CPC G06N 20/00

(57) ABSTRACT

A processor can be caused to receive, from a user compute device of a user, job data and execute a trained machine learning model using the job data to generate an estimation. The trained machine learning model can be trained using a training set including job descriptions correlated to values representing job descriptions. The processor is further caused to select available workers based on profiles associated with the available workers and stored in a database, to generate feature vectors for the available workers. The processor is further caused to determine a ranking for each available worker based on a difference between the job data and the feature vectors. The difference includes a distance between the locations of the user and that available worker. The processor is further caused to automatically assign to the job data the available worker having a highest ranking indicating the available worker has a shortest distance.

### CROSS-REFERENCE TO RELATED APPLICATIONS

This application is a non-provisional U.S. patent application claiming priority to provisional U.S. Patent Application No. 63/398,158, filed Aug. 15, 2022, the entirety of which is hereby incorporated by reference.

### FIELD

The field relates generally to machine learning (ML)/artificial intelligence (AI) to perform automated matching, and more specifically to ML-based automated matched of electricians with customers.

### BACKGROUND

Finding a qualified and skilled personnel to install an electric-vehicle (EV) charger (or other complex electrical device) can often be a challenging task due to the shortage of such specialists, the large amount of unqualified workers on markets that might deliver unpleasant experience or fraudulent services, etc. Electricians, in turn, desire to find those customers who require installation of an EV charger, to be able to get in contact with such customers, to navigate to the work location, and to get the work done. Additionally, an electrician is typically interested to receive a job that satisfies his qualification, skills and remuneration level.

In many known situations, all of these aspects are addressed separately, considering distinct objectives that do not necessarily provide the best match of a customer job to an electrician that would execute. That introduces job cancellations, customer unsatisfaction and other challenges typical for service-to-customer interaction scenarios.

Known ranking and matching methods are available for different domains, including distance-based similarity matching algorithms. All of them, however, typically consider a single data modality. For example, a pointwise approach assumes that each query-document pair in the training data has a numerical or ordinal score. Then the learning-to-rank problem is formulated and is approximated by a regression problem—given a single query-document pair, a score is predicted. For another example, a pairwise approach formulates the problem as a learning-to-rank problem, which is approximated by a classification problem—learning a binary classifier that can tell which document is better in a given pair of documents.

Thus, a need exists for an improved process and apparatus to match electricians with customers.

### SUMMARY

In one or more embodiments, a processor can be caused to receive, from a user compute device of a user, job data and execute a trained machine learning model using the job data to generate an estimation. The trained machine learning model can be trained using a training set including job descriptions correlated to values representing the job descriptions. The processor is further caused to select available workers based on profiles associated with the available workers and stored in a database, to generate feature vectors for the available workers. The processor is further caused to determine a ranking for each available worker based on a difference between the job data and the feature vectors. The difference includes a distance between the locations of the user and that available worker. The processor is further caused to automatically assign to the job data the available worker having a highest ranking indicating the available worker has a shortest distance.

### BRIEF DESCRIPTION OF THE DRAWING

FIG. 1 is a system block diagram of a bi-directional recommender system, according to an embodiment.

FIG. 2 is a flow diagram of a method for automated matching of jobs using machine learning, according to an embodiment.

FIG. 3 is a block diagram of a system for automated matching of jobs using machine learning, according to an embodiment.

### DETAILED DESCRIPTION

Finding a qualified and skilled personnel to install an electrical-vehicle (EV) charger (or other complex electrical device) can often be challenging task due to the shortage of such specialists, the large amount of unqualified workers on markets that might deliver unpleasant experience or fraudulent services, etc. Electricians, in turn, desire to find those customers who require installation of an EV charger, to be able to get in contact with such customers, to navigate to the work location, and to get the work done.

One or more embodiments perform a combination of an automated matching of electrician to a particular job, work load estimation, appointment scheduling and routing of electricians to installation site. Specifically, in one or more embodiments, a bi-directional recommender system considers information from both sides: customer and electrician. This allows the best match of an installation job to a particular electrician as well as provide an optimal (or improved) scheduling and routing for that electrician maximizing (or increased) its revenue.

The one or more embodiments discussed herein can improve the ability for a customer and an electrician to be matched according to their preferences, maximizing (or increasing) the quality of installation, customer satisfaction as well as providing electricians optimal (or improved) conditions for execution and remuneration that they are willing to get for every type of installation and activities associated to them e.g. driving to the site.

The one or more embodiments discussed here perform, for example, the following five steps.

In the first step (also discussed herein as “step 1”), a job is created (defined) by the customer who needs (desires) installation of an EV charger. The job includes, for example, multiple details, including electrical details of the property, potentially installed battery storage, or solar installation, electrical panel details. Additionally, the customer provides, for example, preferred installation date, property address, desired rating of electrician that would be installing the charger. The bi-directional recommender system can accommodate other customer data. All of this information is converted into a fixed-length user-job feature vector.

In the second step (also discussed herein as “step 2”), job costs are estimated using a supervised machine learning model (regression) that is trained beforehand. The training process is performed on the existing pairs of job description and price tag that was assigned by a professional electrician. Job descriptions that contain multiple insights about the property, installed equipment, e.g., solar panels or/and batteries, etc., are represented as numerical values. A non-linear regression model is than trained to minimize the error between the prediction and the ground truth that is the cost provided by professional electrician. The output of the model is an estimated cost of the installation.

In the third step (also discussed herein as “step 3”), all available electricians in a database are selected. Each electrician has its own profile, for example, based on a desired job to execute, a maximum travel time or millage, a preferred routing, a minimal remuneration for a job, a preferred time of the day, schedule details and/or other factors. All of this information is converted into a fixed-length electrician feature vector.

In the fourth step (also discussed herein as “step 4”), a difference between a user-job and all electrician feature vectors is calculated (determined). Note that depending on the user/electrician/platform priorities, a set of weights can be assigned to different feature types to signify particular aspects, e.g., scheduling dates or remuneration amount.

In the fifth step (also discussed herein as “step 5”), all electricians are ranked according to their distance to the user-job vector. The electrician whose vector yields the smallest distance is chosen for the installation job. An automatic assignment of the job to the electrician is performed.

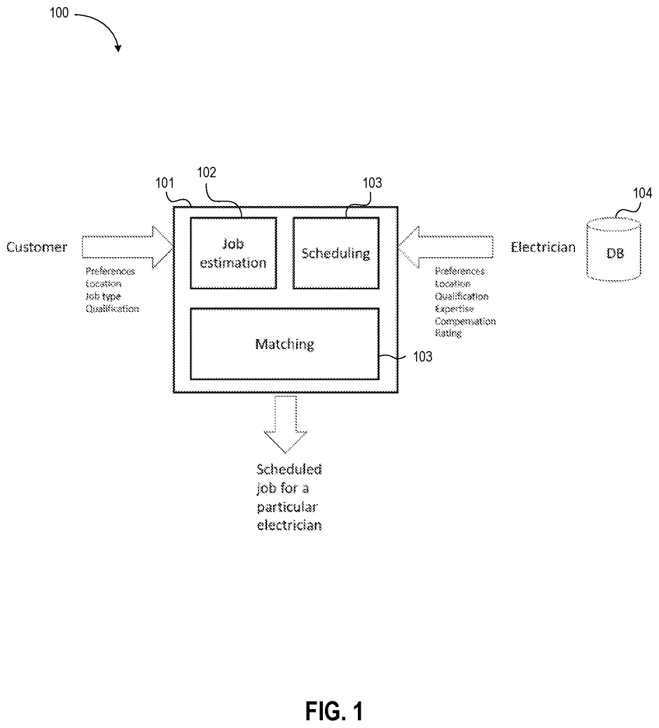

FIG. 1 is a system block diagram of a bi-directional recommender system 100, according to an embodiment. FIG. 1 shows schematically the process described above in connection with a bi-directional recommender system, according to an embodiment. Although not explicitly shown, it should be understood that the bi-directional recommender system can have a processor and a memory coupled to the processor. The processor can be, for example, a hardware-based integrated circuit (IC) or any other suitable processing device configured to run and/or execute a set of instructions or code. For example, the processor be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The memory can be, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor to perform one or more processes, functions, and/or the like including those described herein.

The above-described process considers, for example, aspects related to job, consumer and electrician preferences simultaneously, allowing the ranking of electricians and the matching that corresponds to the lowest difference between what is required to what is available. Although not shown in FIG. 1, other factors can be taken into account when scheduling a job at scheduling 103. For example, external factors such as weather (which can delay and/or affect the timing of the installation and service of electrical components) and traffic.

For following discussion is an example of the bi-directional recommender system in use. For example, consider a residential customer that is living in Washington D.C., has a solar panel installed, and has a battery installed. This customers would like to install an EV charger on the next weekend in the afternoon, would like to have a trusted electrician (with high rating) and is ready to pay a bit more for that. As described above with step 1, user-job feature vector in that case would look as follows:

| | Solar | | | Rating |
|---|---|---|---|---|
| Location | panel | Battery | Appointment | preferred |
| Washington D.C. | yes | Yes | Next weekend, afternoon | 5 |

According to the step 2, a cost for the installation job is estimated, at job estimation 102, by a trained regression model and is 1350 USD. The estimated cost is appended to a user-job feature vector as follows:

| | | | | | Job |
|---|---|---|---|---|---|
| | Solar | | | Rating | estimation, |
| Location | panel | Battery | Appointment | preferred | USD |
| Washington | yes | Yes | Next weekend, | 5 | 1350 |
| D.C. | | | afternoon | | |

According to step 3, available electricians along with their electrician feature vectors are selected from a database 104. In this example, two electricians A and B have their own schedule, customer preferences, desired remuneration, coverage radius and potentially other details. For electrician A, the following electrician feature vector is created (defined):

| | Solar | | | | Preferred min |
|---|---|---|---|---|---|
| | panel | Battery | | | remuneration, |
| Coverage | support | support | Availability | Rating | USD |
| Washington | yes | Yes | Next | 5 | 1200 |
| D.C. | | | weekend, | | |
| | | | afternoon | | |

For electrician B, the following electrician feature vector is created (defined):

| | Solar | | | | Preferred min |
|---|---|---|---|---|---|
| | panel | Battery | | | remuneration, |
| Coverage | support | support | Availability | Rating | USD |
| Baltimore | No | No | Next weekend, | 4.5 | 1400 |
| | | | afternoon | | |

Following the step 4, a difference between the user-job feature vector and each electrician feature vector is calculated. Note that for every category (feature) its own distance measure is applied. This is done to accommodate different type of variables. The distance values for each feature are then scaled so that they have comparable values between each other. This is done to prevent domination of any single feature. The scaling is done according to a standardization procedure.

Additionally, in this step, the weights are assigned to each feature according to its importance. The weights are defined by user and electrician separately and assigned to each feature as an average value. The total sum of all weights equals to 1. For example, following the above example, the user weights for a vector of five features can be [0.0, 0.5, 0.25, 0.25, 0.0, 0.0], and the electrician weights for a vector of five features can be [0.25, 0.0, 0.25, 0.0, 0.0, 0.5]. Following these examples, the average weights are then [0.125, 0.25, 0.25, 0.125, 0.0, 0.25]. Note, that user, electrician and average weights sum up to one, respectively. Consider where electrician A and B have the same weights. The overall weighted distances between user-job vector and electrician vectors would be higher for electrician B than for the electrician A. As the result, electrician A is chosen as match, from matching 103, since his vector yields the smallest distance to the user-job vector.

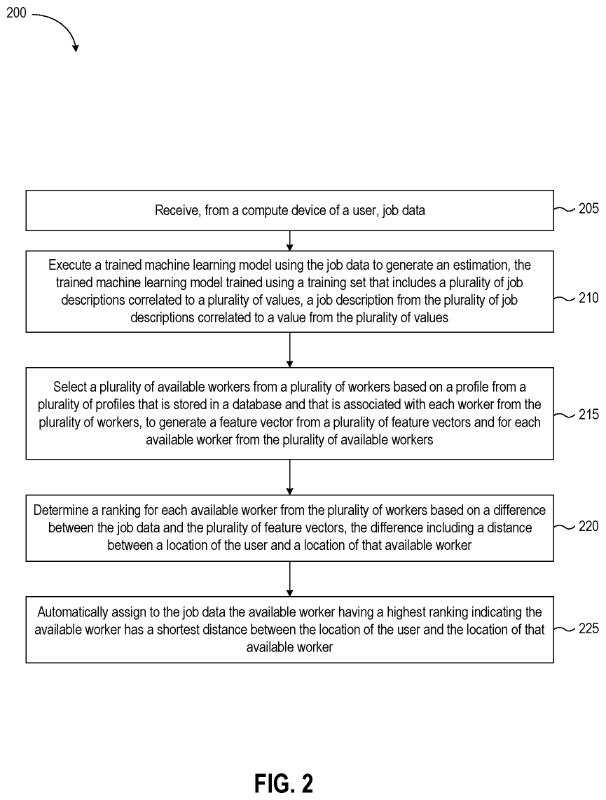

FIG. 2 is a flow diagram of a method 200 for automated matching of jobs using machine learning, according to an embodiment. At 205, the method 200 includes receiving, from a compute device of a user, job data. In some embodiments, the method 200 can include receiving the job data at a processor of a compute device that is different from the compute device operated by the user. For example, the job data can be created by the user that indicates that the user desires to install an electric vehicle (EV) charger. The job data can include, for example, the make and model of a vehicle intended to use the EV charger, information about installing the EV charger such as, for example, electrical details of the EV charger, battery capacity, solar installation, electrical panel detail, and/or the like. In some cases, the user can provide preferred installation time and/or dates, a property address for where the installation is preferred to take place, desired rating of an electrician for installing the EV charger, and/or the like. In some implementations, the method 200 can include generating a feature vector of the job data in which the feature vector can be a fixed-length.

At 210, the method 200 includes executing a trained machine learning model using the job data to generate an estimation. The trained machine learning model can be trained using, for example, a training set that includes a plurality of job descriptions correlated to a plurality of values, where a job description from the plurality of job descriptions is correlated to a value from the plurality of values. In some cases, the machine learning model can be least one of a supervised machine learning model, an unsupervised machine learning model, a non-linear regression model and/or the like. In some implementations, the estimation can be an estimated price or cost for a job (by a specific worker) to satisfy the job data (e.g., a request for installation of an EV charger). In some cases, the job descriptions in the training data can include information such as, for example, insights about the property for installation, installed equipment (e.g. solar panels or/and batteries), and/or the like. The job descriptions can be represented as numerical values. In some cases, the value that the job description is correlated to can be a numerical value that represents the job description (e.g., cost, price, etc.). The machine learning model can be previously trained to minimize errors between the prediction and the ground truth that is the cost provided by workers.

At 215, the method 200 includes selecting a plurality of available workers from a plurality of workers based on a profile from a plurality of profiles that is stored in a database and that is associated with each worker from the plurality of workers (e.g., electricians), to generate a feature vector from a plurality of feature vectors and for each available worker from the plurality of available workers. In some implementations, the feature vectors for the workers can be already generated and stored in the database such that the feature vectors can be retrieved from the database. In some cases, the feature vector for a worker can include information such as, for example specific expertise, maximum travel time or mileage, preferred routing, minimal remuneration for a job, preferred time of the day, schedule details and/or the like. In some cases, the feature vectors for the workers can be a fixed length.

At 220, the method 200 includes determining a ranking for each available worker from the plurality of workers based on a difference between the job data and the plurality of feature vectors, the difference including a distance between a location of the user and a location of that available worker. In some cases, the difference can be between the feature vector of the job data and the feature vectors of the available workers. In some cases, weights can be assigned to different feature types of the feature vectors of the available workers (e.g., preferred scheduling dates, expertise, ratings, locations, etc.) to signify particular aspects of the feature vectors of the available workers.

At 225, the method 200 includes automatically assigning to the job data the available worker having a highest ranking. The highest ranking can indicate the available worker has a shortest distance between the location of the user and the location of that available worker.

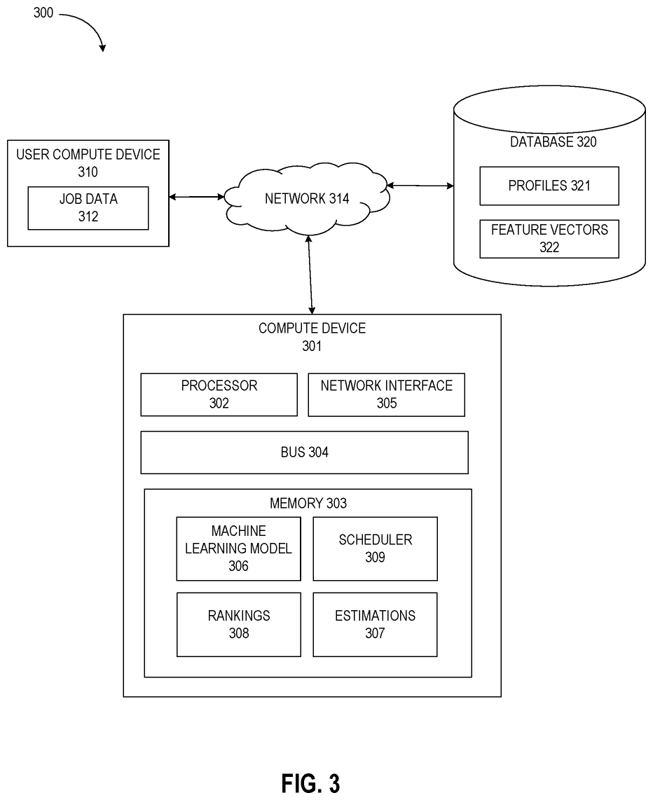

FIG. 3 is a block diagram of a system 300 for automated matching of jobs using machine learning, according to an embodiment. The system 300 can include a compute device 301, a user compute device 310 (e.g., operated by a user), a database 320, and a network 314 in which the compute device 301, the user compute device 310, and the database 320 can communicate with each other. The compute device 301 includes a processor 302 and a memory 303 that communicate with each other, and with other components, via a bus 304. The bus 304 can include be, for example, a memory bus, a memory controller, a peripheral bus, a local bus, and/or the like. The compute device 301 can be or include, for example, a computer workstation, a terminal computer, a server computer, a handheld device (e.g., a tablet computer, a smartphone, etc.), and/or any machine capable of executing a sequence of instructions that specify an action to be taken by that machine, and any combinations thereof. The compute device 301 can also include multiple compute devices that can be used to implement a specially configured set of instructions for causing one or more of the compute devices to perform any one or more of the aspects and/or methodologies described herein.

In some cases, the compute device 301 can include a network interface 305. In some cases, the network interface 305 can be used to connect the compute device 301 to one or more of a variety of networks (e.g., network 314) and one or more remote devices (e.g., user compute device 310, database 320, etc.) connected thereto. In some cases, the network 314 can be, for example, a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or the like. In some instances, the network 314 can be a wireless network such as, for example, a Wi-Fi or wireless local area network (“WLAN”), a wireless wide area network (“WWAN”), and/or a cellular network. In some instances, the network 314 can be a wired network such as, for example, an Ethernet network, a digital subscription line (“DSL”) network, a broadband network, and/or a fiber-optic network. In some cases, the compute device 301 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 314 can be encrypted or unencrypted. In some instances, the network 314 can include multiple networks or subnetworks operatively coupled to one another by, for example, network bridges, routers, switches, gateways and/or the like.

The processor 302 can be or include, for example, a hardware-based integrated circuit (IC), or any other suitable processing device configured to run and/or execute a set of instructions or code. For example, the processor 302 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 302 can be configured to run any of the methods and/or portions of methods discussed herein.

The memory 303 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 302 to perform one or more processes, functions, and/or the like. In some implementations, the memory 303 can include extendable storage units that can be added and used incrementally. In some implementations, the memory 303 can be a portable memory (e.g., a flash drive, a portable hard disk, and/or the like) that can be operatively coupled to the processor 302. In some instances, the memory 303 can be remotely operatively coupled with a compute device (not shown); for example, a remote database device can serve as a memory and be operatively coupled to the compute device. The memory 303 can include various components (e.g., machine-readable media) including, but not limited to, a random-access memory component, a read only component, and/or the like. The memory 303 can further include any number of program modules including, for example, an operating system, one or more application programs, other program modules, program data, and/or the like.

The memory 303 of the compute device 301 can include and/or store a machine learning model 306, a scheduler 309, rankings 308 of available workers, and estimations 307. The machine learning model 306 can be trained and/or executed to generate the estimations 307 of a job request specified in job data 312 provided by a user operating the user compute device 310. In some cases, the machine learning model 306 can be or include at least one of a supervised machine learning model, an unsupervised machine learning model, a tree-based model, a deep neural network model (DNN), an artificial neural network (ANN) model, a fully connected neural network, a convolutional neural network (CNN), a residual network model, a region proposal network (RPN) model, a feature pyramid network (FPN) model, a generative adversarial network (GAN), a K-Nearest Neighbors (KNN) model, a Support Vector Machine (SVM), a decision tree, a random forest, an analysis of variation (ANOVA), boosting, a Naïve Bayes classifier, and/or the like. The machine learning model 306 can be trained using a training set that includes a plurality of job descriptions correlated to a plurality of values. The values can represent the job descriptions or costs associated with the job descriptions. The job descriptions can be received from previous job data about and/or provided by previous users. The values can be previously generated values (or previously generated estimations of costs) for jobs of those previous job data. In some cases, the training set can include pairs of a job description to a value that is assigned to a specific worker (e.g., price for the specific worker to perform the job). The training set can be labeled and used to train the machine learning model 306 to generate a more robust machine learning model 306.

The machine learning model 306 (trained) can be executed by the processor 302 to generate the estimations 307 for the job request specified in the job data 312. For example, an estimation can be or include a cost for an installation job (performed by a worker) requested by the user. The estimations 307 can include an estimation for each worker (whose information is stored in the database 320) in completing the job request specified in the job data 312. In some cases, the processor 302 can be caused to generate feature vectors for the job request for each estimation by appending the estimation for a specific worker to the job data 312. In other words, the job data 312 can be converted into a feature vector having a fixed length that represents numerical values for each worker, to identify difference between each worker with respect to the job data 312. For example, if one worker has an estimation of $1,350 for completing the job request, the estimation of $1,350 can be appended into the feature vector for the job data 312 associated with that worker.

The rankings 308 can include ranking for each available worker that is able to complete the job request specified in the job data 312. For instance, the processor 302 can select a set of available workers and can rank each available worker; the available worker with the highest ranking can indicate the best available worker for the job request specified in the job data 312. In some cases, the job data 312 can include weights (e.g., factors prioritized by the user) in which the available worker that best matches preferences of the user can be ranked the highest. In some cases, to determining the rankings 308, the processor 302 can be caused to find differences between the feature vectors 322 of the available workers and the job data 312. In some cases, finding the differences can include comparing the feature vectors 322 of the available workers and the feature vectors converted from the job data 312 (that include appended estimations for each available worker). In other words, comparing data having fixed length and/or sharing a format enables the processor 302 to efficiently and/or accurately determine differences and/or similarities in data. In some cases, the available worker that has the shortest distance from the user can be ranked the highest.

The scheduler 309 can be or include a software and/or hardware module configured to automatically assign the job data 312 to the available worker having the highest ranking. The available worker assigned to job data 312 can be the worker assigned to perform the job request specified in the job data 312.

The user compute device 310 can be operated by the user and provide the job data 312 to the compute device 301 via the network 314. In some cases, the user compute device 310 can be structurally similar to the compute device 301. The job data 312 can include a request for a job. In some cases, the job data 312 can include additional information and/or preferences such as, for example, specific cost, distance between the user and a worker, installation type, and/or the like.

The database 320 can store a set of profiles 321 of workers. In some cases, the profiles 321 can include information about the workers such as, for example, years of experience, name, location, expertise, ratings, reviews, and/or the like. In some cases, the compute device 301 can convert the profiles 321 into feature vectors 322 and store the feature vectors into the database 320. The feature vectors 322 can be or include a numerical representation of the profiles 321 of the workers. The compute device 301 can retrieve the feature vectors 322 to determine the best available workers to assign to multiple users and job requests, as discussed above.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

What is claimed is:

1. A non-transitory, processor-readable medium storing instructions that when executed by a processor, cause the processor to:
receive, from a compute device of a user, job data;
execute a trained machine learning model using the job data to generate an estimation, the trained machine learning model trained using a training set that includes a plurality of job descriptions correlated to a plurality of values, a job description from the plurality of job descriptions correlated to a value from the plurality of values;
select a plurality of available workers from a plurality of workers based on a profile from a plurality of profiles that is stored in a database and that is associated with each worker from the plurality of workers, to generate a feature vector from a plurality of feature vectors and for each available worker from the plurality of available workers;
determine a ranking for each available worker from the plurality of workers based on a difference between the job data and the plurality of feature vectors, the difference including a distance between a location of the user and a location of that available worker; and
automatically assign to the job data the available worker having a highest ranking indicating the available worker has a shortest distance between the location of the user and the location of that available worker.
